(19) United States
(12) Patent Application Publication
(10) Pub. No.: US 2025/0296562 A1
(43) Pub. Date: Sep. 25, 2025

(54) STORAGE MEDIUM, VEHICLE CONTROL DEVICE, AND VEHICLE CONTROL METHOD

(71) Applicant: HONDA MOTOR CO., LTD., Tokyo (JP)

(72) Inventor: Junichiro Chiba, Tokyo (JP)

(21) Appl. No.: 19/059,372

(22) Filed: Feb. 21, 2025

(30) Foreign Application Priority Data
Mar. 19, 2024 (JP) 2024-043159

(51) Int. Cl. B60W 30/14; B60W 50/00; G06V 20/56

(52) U.S. Cl. CPC B60W 30/143; B60W 50/00; G06V 20/588; B60W 2050/0083; B60W 2420/403; B60W 2520/10; B60W 2520/14; B60W 2540/18; B60W 2552/30; B60W 2556/40

(57) ABSTRACT

A storage medium of an embodiment is a non-transient storage medium storing computer-readable instructions to be executed by a computer. The instructions include recognizing a surrounding conditions of a vehicle based on detection result of an external environment detection device, setting a first target speed of the vehicle based on the surrounding conditions, setting a second target speed of the vehicle based on map information, selecting one of the first target speed and the second target speed and controlling a speed of the vehicle based on the selected target speed, setting a target speed by combining the first target speed and the second target speed at a ratio according to traveling conditions of the vehicle when a curved road is present in a traveling direction of the vehicle, and controlling the speed of the vehicle based on the set target speed.

### CROSS-REFERENCE TO RELATED APPLICATION

This application is based upon and claims the benefit of priority from Japanese Patent Application No. 2024-043159, filed Mar. 19, 2024, the entire content of which is incorporated herein by reference.

### BACKGROUND

### Field of the Invention

The present invention relates to a storage medium, a vehicle control device, and a vehicle control method.

### Description of Related Art

In recent years, there has been an increased effort to provide access to sustainable transport systems that take into account the most vulnerable transport participants. In order to realize this effort, research and development into preventive safety technologies have been focused to further improve road safety and convenience. In relation to this, a technique has been disclosed for controlling the vehicle's traveling speed at a set speed according to the magnitude of the curve on the road (see, for example, International Publication No. WO 2020/230300).

### SUMMARY

Incidentally, in the preventive safety technology, when a target speed is set using the curvature of the curved road acquired from the detection results of a camera, the curvature acquired from the detection results of the camera may change significantly due to a change in the direction of the vehicle caused by the steering operation of the occupant. Therefore, the problem was that the target speed was sometimes not properly adjusted according to the shape of the curved road.

In order to solve the above problems of the present invention, an object is to provide a storage medium, a vehicle control device, and a vehicle control method that are capable of setting a more appropriate target speed even on curved roads. Then, this will ultimately contribute to the development of a sustainable transportation system.

The storage medium, the vehicle control device, and the vehicle control method according to the embodiment adopt the following configuration.
(1) An aspect of the invention is a non-transient storage medium storing computer-readable instructions to be executed by a computer. The instructions include recognizing a surrounding conditions of a vehicle based on detection result of an external environment detection device, setting a first target speed of the vehicle based on the surrounding conditions, setting a second target speed of the vehicle based on map information, selecting one of the first target speed and the second target speed and controlling a speed of the vehicle based on the selected target speed, setting a target speed by combining the first target speed and the second target speed at a ratio according to traveling conditions of the vehicle when a curved road is present in a traveling direction of the vehicle, and controlling the speed of the vehicle based on the set target speed.
(2) In the aspect of (1), a ratio of the second target speed is increased when a relative speed between the target speed and the speed of the vehicle is large.
(3) In the aspect of (1), a ratio of the smaller target speed between the first target speed and the second target speed is increased when a relative speed between the target speed and the speed of the vehicle is large.
(4) In the aspect of (1), the first target speed and the second target speed are set according to a curvature radius or curvature of the curved road.
(5) In the aspect of (4), the first target speed is adjusted based on a yaw rate or steering angle of the vehicle.
(6) Another aspect of the present invention is a vehicle control device including: a recognition unit which recognizes a surrounding conditions of a vehicle based on detection result of an external environment detection device; a target speed setting unit which sets a first target speed of the vehicle based on the surrounding conditions recognized by the recognition unit and sets a second target speed of the vehicle based on map information; and a speed control unit which selects one of the first target speed and the second target speed and controls the speed of the vehicle based on the selected target speed, wherein the target speed setting unit sets a target speed by combining the first target speed and the second target speed at a ratio according to traveling conditions of the vehicle when a curved road is present in a traveling direction of the vehicle, and wherein the speed control unit controls the speed of the vehicle based on the set target speed.
(7) Still another aspect of the present invention is A vehicle control method for causing a computer to execute: recognizing surrounding conditions of a vehicle based on detection result of an external environment detection device; setting a first target speed of the vehicle based on the surrounding conditions; setting a second target speed of the vehicle based on map information; selecting one of the first target speed and the second target speed and controlling a speed of the vehicle based on the selected target speed; setting a target speed by combining the first target speed and the second target speed at a ratio according to traveling conditions of the vehicle when a curved road is present in a traveling direction of the vehicle; and controlling the speed of the vehicle based on the set target speed.

According to the aspects (1) to (7), a more appropriate target speed can be set even on curved roads.

### BRIEF DESCRIPTION OF THE DRAWINGS

FIG. 1 is a configuration diagram of a vehicle system that adopts a vehicle control device according to an embodiment.

FIG. 2 is a diagram illustrating a situation in which a vehicle is traveling near a curved road.

FIG. 3 is a diagram showing an example of a target speed relative to a curvature radius of a traveling lane.

FIG. 4 is a diagram illustrating a difference in vehicle speed control based on a first target speed and a second target speed set for the same curvature radius.

FIG. 5 is a diagram illustrating a change in vehicle speed based on an adjusted target speed.

FIG. 6 is a flowchart showing an example of a process executed by a driving assistance device of an embodiment.

### DESCRIPTION OF EMBODIMENTS

Hereinafter, embodiments of a storage medium, a vehicle control device, and a vehicle control method of the present invention will be described with reference to the drawings.

### Overall Configuration

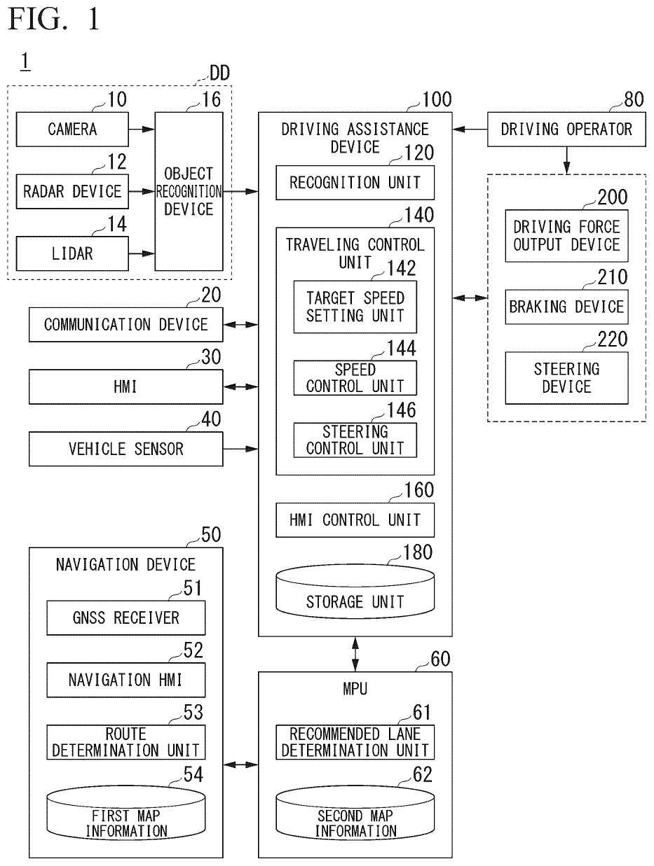

FIG. 1 is a configuration diagram of a vehicle system 1 that adopts a vehicle control device according to an embodiment. A vehicle on which the vehicle system 1 is mounted (hereinafter, referred to as vehicle M) is, for example, a two-wheeled, three-wheeled, or four-wheeled vehicle, and the driving source thereof is an internal combustion engine such as a diesel engine or a gasoline engine, an electric motor, or a combination of these. The electric motor is operated using electric power generated by a generator connected to the internal combustion engine, or using discharged electric power from a secondary battery or a fuel cell.

The vehicle M is equipped with, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driving operator 80, a driving assistance device 100, a driving force output device 200, a braking device 210, and a steering device 220. These devices and equipment are connected to each other by multiple communication lines such as a controller area network (CAN) communication line, serial communication lines, wireless communication networks, etc. Furthermore, the configuration shown in FIG. 1 is merely an example, and some of the components may be omitted or other components may be added. The driving assistance device 100 is an example of a “vehicle control device.”

The camera 10 is a digital camera that uses a solid-state image sensor such as a charge coupled device (CCD) or a complementary metal oxide semiconductor (CMOS). The camera 10 is attached to an arbitrary position of the vehicle M. For example, when capturing an image of the area in front of the vehicle M, the camera 10 is attached to the top of the front windshield, the back of the rear-view mirror, etc. The camera 10, for example, periodically and repeatedly captures images of the surroundings of the vehicle M. The camera 10 may be a stereo camera.

The radar device 12 emits radio waves such as millimeter waves around the vehicle M and detects radio waves reflected by objects (reflected waves) to detect at least the position (distance and orientation) of the objects. The radar device 12 is attached to an arbitrary position of the vehicle M. The radar device 12 may detect the position and speed of an object by a frequency modulated continuous wave (FM-CW) method.

The LIDAR 14 irradiates light (or electromagnetic waves with wavelengths close to light) around the vehicle M and measures the scattered light. The LIDAR 14 detects the distance to the target based on the time from light emission to light reception. The irradiated light is, for example, a pulsed laser light. The LIDAR 14 is attached to an arbitrary position of the vehicle M.

The object recognition device 16 executes sensor fusion processing on some or all of the detection results from the camera 10, the radar device 12, and the LIDAR 14 to recognize the position, type, speed, etc. of the object. The object recognition device 16 outputs the detection results to the driving assistance device 100. The object recognition device 16 may directly output the detection results of the camera 10, the radar device 12, and the LIDAR 14 to the driving assistance device 100. The object recognition device 16 may be omitted from the vehicle M. Some or all of the camera 10, the radar device 12, the LIDAR 14, and the object recognition device 16 are examples of an “external environment detection device DD.”

The communication device 20 communicates with other vehicles in the vicinity of the vehicle M using, for example, a cellular network, a Wi-Fi network, Bluetooth (registered trademark), dedicated short range communication (DSRC), etc., or communicates with various server devices via a wireless base station.

The HMI 30 presents various information to the occupants (including the driver) of the vehicle M and accepts input operations by the occupants. The HMI 30 includes, for example, a display unit and a speaker. The display unit is, for example, a liquid crystal display (LCD) or an organic electro luminescence (EL) display device. The display unit displays various images (including video). The display unit may be integrated with an input unit as a touch panel. The speaker outputs a predetermined sound (e.g., an alarm, etc.). Further, the HMI 30 may be a microphone, a buzzer, a vibration generator (vibrator), a touch panel, a switch, a key, etc. in addition to (or instead of) the display unit and the speaker. The switch includes, for example, a changeover switch for switching whether or not a predetermined driving control is executed in the driving assistance device 100.

The vehicle sensor 40 includes a speed sensor that detects the speed of the vehicle M, an acceleration sensor that detects the acceleration, a yaw rate sensor that detects the yaw rate (for example, the rotational angular velocity around a vertical axis passing through the center of gravity of the vehicle M), a steering angle sensor that detects the steering angle (the angle (actual steering angle) or the amount of torque of the steering wheel of the vehicle M), and a direction sensor that detects the direction of the vehicle M. Further, the vehicle sensor 40 may be provided with a position sensor that detects the position of the vehicle M. The position sensor is, for example, a sensor that acquires position information (longitude and latitude information) from a global positioning system (GPS) device. Further, the position sensor may be a sensor that acquires position information using a global navigation satellite system (GNSS) receiver 51 of the navigation device 50.

The navigation device 50 includes, for example, a GNSS receiver 51, a navigation HMI 52, and a route determination unit 53. The navigation device 50 stores first map information 54 in a storage device such as a hard disk drive (HDD) or a flash memory. The GNSS receiver 51 determines the position of the vehicle M based on signals received from GNSS satellites. The position of the vehicle M may be identified or supplemented by an inertial navigation system (INS) that uses the output of the vehicle sensor 40. The navigation HMI 52 includes a display device, a speaker, a touch panel, keys, etc. The navigation HMI 52 may be partially or entirely common to the HMI 30 described above. The route determination unit 53 determines, for example, a route (hereinafter, a route on a map) from the position of the vehicle M specified by the GNSS receiver 51 (or an arbitrary input position) to a destination input by the occupant using the navigation HMI 52 by referring to the first map information 54. The first map information 54 is, for example, information in which road shapes are expressed by links indicating roads and nodes connected by the links. The first map information 54 may include the curvature radius or the curvature of the road (lane), point of interest (POI) information, etc. The route on the map is output to the MPU 60. The navigation device 50 may provide route guidance using the navigation HMI 52 based on the route on the map. The navigation device 50 may be realized by the functions of a terminal device such as a smartphone or a tablet terminal owned by the occupant. The navigation device 50 may transmit the current position and the destination to a navigation server via the communication device 20, and acquire a route equivalent to the route on the map from the navigation server.

The MPU 60 includes, for example, a recommended lane determination unit 61 and stores second map information 62 in a storage device such as an HDD or a flash memory. The recommended lane determination unit 61 divides the route on the map provided by the navigation device 50 into multiple blocks (for example, every 100 m in the vehicle traveling direction) and determines the recommended lane for each block by referring to the second map information 62. The recommended lane determination unit 61 determines which lane from the left the vehicle should travel in. Further, when a branch point is present on the route on the map, the recommended lane determination unit 61 determines a recommended lane so that the vehicle M can travel along a reasonable route to proceed to the branch point. The second map information 62 is map information with higher accuracy than the first map information 54. The second map information 62 includes, for example, information on the center of lanes, or information on lane boundaries such as road dividing lines, medians, road shoulders, curbs, etc., which divide lanes. The second map information 62 may include road information, traffic regulation information, address information (address and postal code), facility information, telephone number information, and the like. The second map information 62 may be updated at any time by the communication device 20 communicating with other devices. Further, the first map information 54 and the second map information 62 may be stored in a storage unit within the driving assistance device 100. Further, the first map information 54 and the second map information 62 may be configured as one piece of map information.

The driving operator 80 includes, for example, a steering wheel 82, an accelerator pedal 84, a brake pedal 86, a turn signal switch, a shift lever, and other operators. The driving operator 80 is attached with a sensor that detects the operation amount or whether or not operation is executed, and the detection results are output to the driving assistance device 100, or some or all of the driving force output device 200, the braking device 210, and the steering device 220.

The driving force output device 200 outputs a driving force (torque) for the vehicle M to travel to the drive wheels. The driving force output device 200 includes, for example, a combination of an internal combustion engine, an electric motor, a transmission, and an electronic control unit (ECU) that controls these. The ECU controls the above configuration according to information input from the driving assistance device 100 or information input from the driving operator 80.

The braking device 210 includes, for example, a brake caliper, a cylinder that transmits hydraulic pressure to the brake caliper, an electric motor that generates hydraulic pressure in the cylinder, and an ECU. The ECU controls the electric motor according to information input from the driving assistance device 100 or information input from the driving operator 80 so that a brake torque corresponding to the braking operation is output to each wheel. The braking device 210 may include a backup mechanism that transmits hydraulic pressure generated by operating a brake pedal included in the driving operator 80 to a cylinder via a master cylinder. Furthermore, the braking device 210 is not limited to the above-described configuration, and may be an electronically controlled hydraulic braking device that controls an actuator according to information input from the driving assistance device 100 and transmits hydraulic pressure from a master cylinder to the cylinder.

The steering device 220 includes, for example, a steering ECU and an electric motor. The electric motor, for example, applies a force to a rack and pinion mechanism to change the direction of the steered wheels. The steering ECU drives the electric motor according to information input from the driving assistance device 100 or information input from the driving operator 80 to change the direction of the steered wheels.

### Driving Assistance Device

The driving assistance device 100 includes, for example, a recognition unit 120, a traveling control unit 140, an HMI control unit 160, and a storage unit 180. Each of the recognition unit 120, the traveling control unit 140, and the HMI control unit 160 is realized by, for example, a hardware processor such as a central processing unit (CPU) executing a program (software). Further, some or all of these components may be realized by hardware (including circuitry) such as a large scale integration (LSI), an application specific integrated circuit (ASIC), a field-programmable gate array (FPGA), a graphics processing unit (GPU), or a system on chip (SOC), or may be realized by a combination of software and hardware. The program may be stored in advance in a storage device (a storage device having a non-transient storage medium) such as an HDD or flash memory of the driving assistance device 100, or may be stored in a removable storage medium such as a DVD or CD-ROM, and installed in the HDD or flash memory of the driving assistance device 100 by mounting the storage medium (non-transient storage medium) in a drive device. The HMI control unit 160 is an example of a “notification control unit.”

For example, settings are made within the driving force output device 200, the braking device 210, and the steering device 220 so that instructions from the driving assistance device 100 to the driving force output device 200, the braking device 210, and the steering device 220 are executed with priority over detection results from the driving operator 80. Regarding braking, if the braking force based on the operation amount of the brake pedal 86 is larger than the instruction from the driving assistance device 100, the latter may be set to be executed with priority. Further, as a mechanism for giving priority to the execution of instructions from the driving assistance device 100, a communication priority in an in-vehicle local area network (LAN) may be used. Regarding steering, the steering force may be set to be added to the steering force based on the instruction from the driving assistance device 100 and the steering force based on the operation amount of the steering wheel 82 by the driver.

The storage unit 180 may be realized by the above various storage devices, or a solid state drive (SSD), an electrically erasable programmable read only memory (EEPROM), a read only memory (ROM), a random access memory (RAM), or the like. The storage unit 180 stores, for example, programs (for example, vehicle control programs), information used by components in the driving assistance device 100, and various other information. Further, the storage unit 180 may store the above map information (the first map information 54 and the second map information 62).

The recognition unit 120 recognizes the surrounding conditions of the vehicle M based on information acquired from the map information (the first map information 54 and the second map information 62) based information of the detection result of the external environment detection device DD or position information of the vehicle M acquired by the vehicle sensor 40, etc. For example, the recognition unit 120 recognizes the position, speed, acceleration, and other conditions of objects present in the vicinity (for example, within a predetermined distance from the vehicle M). The objects are, for example, other vehicles, bicycles, pedestrians, etc. The position of the object is recognized as a position on an absolute coordinate system with a representative point of the vehicle M (such as the center of gravity or the center of the drive shaft) as the origin, and is used for control. The position of the object may be expressed by a representative point such as the center of gravity or a corner of the object, or may be expressed by an area. The “state” of the object may include the acceleration or jerk of the object, or its “behavioral state” (e.g., whether the object is changing lanes or about to change lanes). Further, the recognition unit 120 recognizes the relative position and relative speed of the object.

Further, the recognition unit 120 recognizes the shape of the lanes around the vehicle M. For example, the recognition unit 120 recognizes the shape and type of the lane (traveling lane) in which the vehicle M is traveling and the adjacent lanes adjacent to the traveling lane based on the detection result of the external environment detection device DD. For example, the recognition unit 120 executes known image analysis processing such as edge extraction and feature extraction on the image captured by the camera 10, and recognizes areas defined by road dividing lines on the left and right sides of the vehicle M as traveling lanes based on the analysis processing results. Furthermore, the recognition unit 120 recognizes adjacent lanes based on road dividing lines that extend parallel to the road dividing lines (within a predetermined tolerance range). Further, the recognition unit 120 may recognize the shape and type of lane based on the positions of objects such as curbs and median strips detected by the radar device 12, the LIDAR 14, etc., or may combine these recognition results. Furthermore, the recognition unit 120 may recognize the curvature radius based on the shape of the recognized lane or road dividing line, or may recognize that the road is a curved road when the curvature radius is smaller than a threshold value. Furthermore, the curvature radius may be replaced with the curvature the curvature. The same applies to the following description.

Further, the recognition unit 120 may refer to map information based on the position information of the vehicle M recognized by the vehicle sensor 40, and recognize the positions and shapes of lanes around the vehicle M, the traveling lane, and adjacent lanes. Further, the recognition unit 120 recognizes the curvature radius of the traveling lane of the vehicle M from map information.

Further, the recognition unit 120 may execute character recognition or the like on the image captured by the camera 10 to recognize the speed limit (legal speed) of the traveling lane from road signs, etc., or may recognize the speed limit of the traveling lane from map information.

The traveling control unit 140 controls the traveling of the vehicle M based on the surrounding conditions of the vehicle M recognized by the recognition unit 120. For example, the traveling control unit 140 executes driving control to control at least one of the steering and the speed of the vehicle M based on the surrounding conditions. The driving control includes controls according to various functions such as cruise control, adaptive cruise control (ACC), lane keeping assistance system (LKAS), and collision mitigation braking system (CMBS), but is not limited thereto. Further, the traveling control unit 140 may execute a plurality of driving controls in parallel.

The cruise control is a function that controls the speed of the vehicle M to approach a target speed even when the driver does not depress the accelerator pedal when the vehicle M is traveling at a constant speed. The ACC is a function that controls the speed of vehicle M so that the vehicle can follow the preceding vehicle while maintaining the distance to the preceding vehicle within a predetermined range. The LKAS is a function that controls the steering of the vehicle M so that the vehicle M does not deviate from the traveling lane. The CMBS is a function that controls deceleration of the vehicle M when it is determined that there is a possibility that the vehicle M may approach or come into contact with an object. Furthermore, the above driving control may be switched on or off by the driver operating a changeover switch or the like of the HMI 30, or may be switched on or off depending on the traveling conditions. Further, the traveling control unit 140 may control the traveling of the vehicle M through the operation of the driving operator 80 by the driver.

Further, the traveling control unit 140 includes, for example, a target speed setting unit 142, a speed control unit 144, and a steering control unit 146. The target speed setting unit 142 sets a target speed that is a reference for the speed of the vehicle M during operation of driving control such as cruise control. For example, the target speed setting unit 142 may set the target speed based on the speed limit of the traveling lane of the vehicle M, or may set the target lane based on vehicle speed information set by the driver of the vehicle M via the HMI 30. Furthermore, when the driver sets the target speed, the driver is allowed to set the target speed within a range between upper and lower limits according to the speed limit of the traveling lane of the vehicle. Further, the target speed setting unit 142 may set (adjust) the target speed depending on the speed of other vehicles (for example, a preceding vehicle) or the curvature radius when the traveling lane is a curved road.

The speed control unit 144 controls the speed of the vehicle M so that the vehicle M approaches a target speed during operation of driving control such as cruise control. Further, when the ACC function is operating, the speed control unit 144 controls the acceleration and deceleration of the vehicle M so that the vehicle M follows the preceding vehicle at a predetermined distance.

The steering control unit 146 executes steering control so that the vehicle M does not deviate from the traveling lane (for example, so that the vehicle M travels in the center of the lane) during operation of driving control such as LKAS. Further, the speed control unit 144 and the steering control unit 146 execute speed control and steering control to avoid contact between the vehicle M and an object.

The HMI control unit 160 notifies the occupants of the vehicle M of predetermined information through the HMI 30. The predetermined information includes, for example, information on the traveling of the vehicle M, such as information on the state of the vehicle M and information on driving control. The information on the state of the vehicle M includes, for example, the speed of the vehicle M, the engine speed, the shift position, etc. Further, the information on the driving control includes, for example, the type of driving control being executed, the reason for the operation, the operation state, etc. Further, the information on driving control may include information on a driver's attention (warning). Further, the predetermined information may include information related to the current location and destination of the vehicle M, the remaining fuel level, etc., and may also include information unrelated to the traveling control of the vehicle M, such as television programs, content (e.g., movies) stored on a storage medium such as a DVD, etc.

For example, the HMI control unit 160 may generate an image including the above predetermined information and display the generated image on the display unit of the HMI 30, or may generate a sound indicating the predetermined information and output the generated sound from the speaker of the HMI 30. The timing at which sound is output includes, for example, the timing at which driving control is started or stopped (ended), the timing at which the displayed image is switched, the timing at which the vehicle M enters a predetermined state, etc. Further, the HMI control unit 160 may output the information received by the HMI 30 to the traveling control unit 140, etc.

### Traveling Control Unit

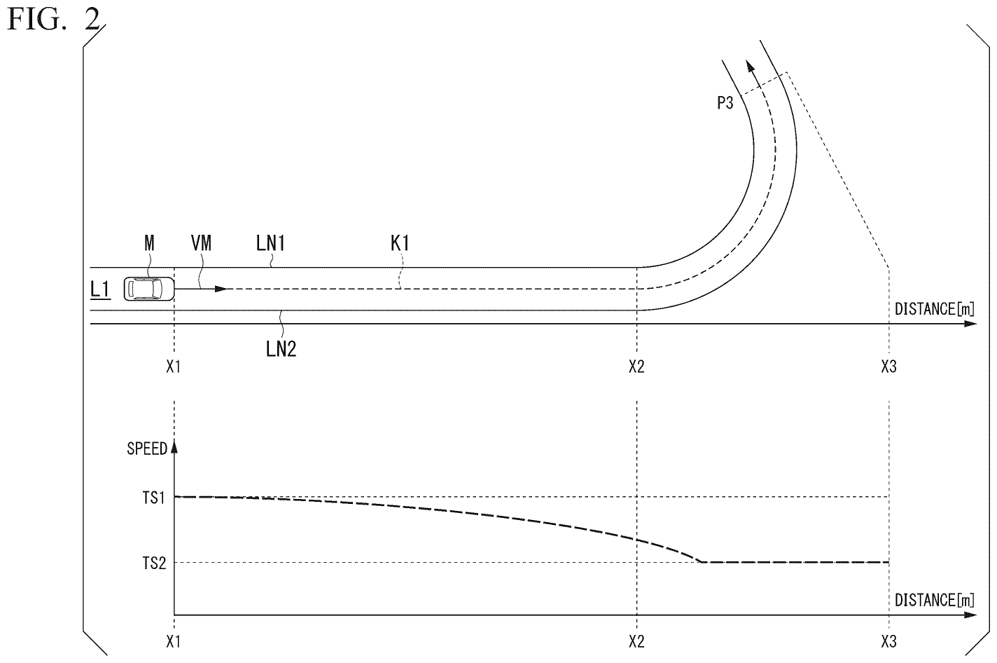

Next, the functions of the traveling control unit 140 in the embodiment will be described in detail. Hereinafter, as an example, speed control around a curved road during cruise control will be described. FIG. 2 is a diagram illustrating a situation in which the vehicle M is traveling near a curved road. In the example of FIG. 2, the vehicle M is traveling at a speed VM on a lane L1 defined by road dividing lines LN1 and LN2. In the example of FIG. 2, a curved road is present in the traveling direction (within a predetermined distance) of the vehicle M. In addition, the example of FIG. 2 also shows the speed change with respect to the traveling position of the vehicle M.

For example, when cruise control is operating on a straight road section (the section from point X1 to point X2 shown in FIG. 2), the traveling control unit 140 controls the speed VM of the vehicle M so that the speed VM falls within a predetermined speed range from the target speed (for example, target speed TS1) set by the target speed setting unit 142. For example, when the speed limit of the lane L1 is 80 [km/h], the target speed setting unit 142 sets the target speed TS1 to a speed near 80 [km/h], and the speed control unit 144 executes speed control so that the relative speed between the speed VM of the vehicle M and the target speed TS1 is within a predetermined range (for example, +5 km). Furthermore, the target speed may be set under predetermined conditions by an input operation of the occupant. Furthermore, in addition to (or instead of) cruise control, when LKAS control is operating, the steering control unit 146 executes steering control so that the vehicle M travels along a central path K1 of the lane L1 in addition to the above control.

Here, when the recognition unit 120 recognizes that a curved road (curved road section) is present within a predetermined distance ahead (in the traveling direction) of the vehicle M, the target speed setting unit 142 adjusts the target speed of the vehicle M. In this case, the target speed setting unit 142 sets a target speed TS2 that is smaller than the target speed TS1 for traveling in a straight road section according to the smallest curvature radius of the curved road that can be recognized by the camera 10, for example. For example, the target speed setting unit 142 sets the target speed TS2 which becomes smaller as the curvature radius becomes smaller (the curvature becomes larger). Then, the speed control unit 144 executes speed control so that the relative speed between the speed VM of the vehicle M and the target speed TS2 falls within a predetermined range when the vehicle M actually travels on a curved road. In the example of FIG. 2, the speed is controlled so that the relative speed is within a predetermined range near the entrance of the curved road (point X2 shown in FIG. 2), and that speed is maintained until the vehicle passes through the curved road. Furthermore, when the vehicle M is traveling on a curved road, the target speed setting unit 142 may acquire the yaw rate or steering angle of the vehicle M from the vehicle sensor 40, adjust the target speed TS2 at a predetermined timing (or a predetermined period) according to the acquired yaw rate or steering angle, and execute speed control of the vehicle M according to the adjusted target speed TS2. Since the attitude of the vehicle M can be recognized from the yaw rate or steering angle, the target speed can be adjusted to a more appropriate one depending on the current situation of the vehicle M (attitude, etc.).

Further, when the vehicle passes through a curved road (when the vehicle passes point X3 at the exit of the curved road shown in FIG. 2), the traveling control unit 140 sets a new target speed based on the surrounding conditions recognized by the recognition unit 120, and traveling control is executed based on the set target speed. Furthermore, when there is an object such as another vehicle around the vehicle M, the traveling control unit 140 executes speed control and steering control to avoid contact with the object, and warns (notifies) the occupants via the HMI control unit 160.

Here, the method for setting the target speed when a curved road is recognized includes a method for setting a target speed (first target speed) according to a curvature radius (first curvature radius) acquired based on the detection result of the external environment detection device DD such as the camera 10 or the yaw rate (or steering angle) of the vehicle M and a method for referring to map information based on position information of the vehicle M, acquiring a curvature radius (second curvature radius) of a lane corresponding to the position information from the map information, and setting a target speed (second target speed) according to the acquired second curvature radius.

Furthermore, in the case of map information, there may be an error with the actual curvature radius, or the map information may not be up to date and may differ from the actual curvature radius. Therefore, the target speed setting unit 142 sets the second target speed set according to the curvature radius stored in the map information to be smaller than the first target speed set according to the curvature radius derived from the detection result of the external environment detection device DD or the yaw rate (or steering angle) of the vehicle M, even if the curvature radius is the same.

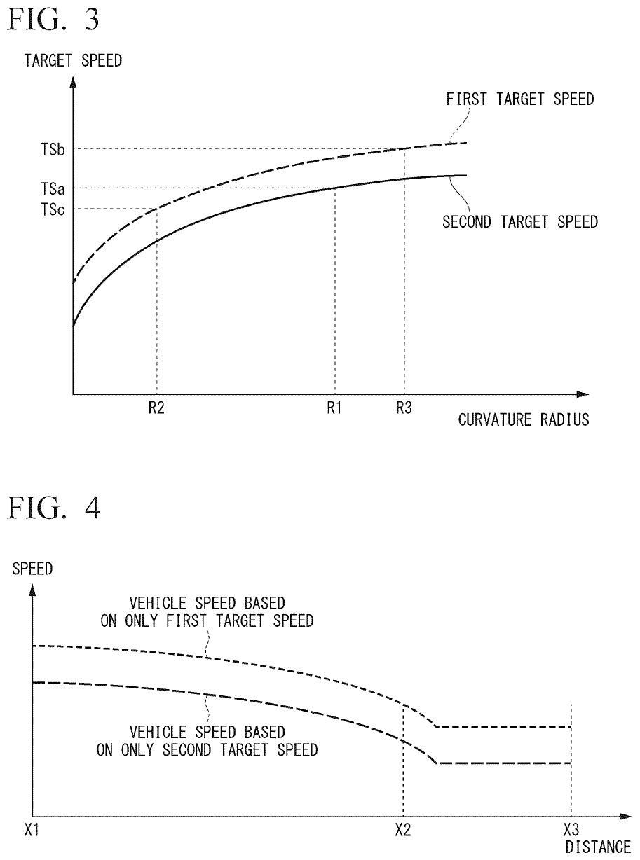

FIG. 3 is a diagram showing an example of a target speed relative to a curvature radius of a traveling lane. In the example of FIG. 3, the horizontal axis indicates the curvature radius R of the traveling lane, and the vertical axis indicates the target speed of the vehicle M set by the target speed setting unit 142. The target speed increases as the curvature radius R increases, but as shown in FIG. 3, the first target speed is set higher than the second target speed. Therefore, as shown in FIG. 2, the speed change on the road also differs between the first target speed and the second target speed. Furthermore, the information shown in FIG. 3 is stored in, for example, the storage unit 180, and is referred to when setting the target speed.

The speed control unit 144 sets the first target speed and the second target speed, selects one of the first target speed and the second target speed, and controls the speed of the vehicle M based on the selected target speed. FIG. 4 is a diagram illustrating a difference in speed control of the vehicle M based on the first target speed and the second target speed set for the same curvature radius. In the example of FIG. 4, the horizontal axis indicates the distance from point X1 to point X3, and the vertical axis indicates the speed VM of the vehicle M. As shown in FIG. 4, when the vehicle M travels between points X1 to X3, the speed VM of the vehicle M changes in a higher state when the first target speed is set than when the second target speed is set.

For example, as shown in FIG. 3, when there is a difference between the target speeds of a predetermined value or more, the speed control unit 144 selects the smaller target speed between the first target speed and the second target speed (low select control), and executes speed control such that the relative speed of the speed VM of the vehicle M relative to the selected target speed becomes smaller than a predetermined speed. Accordingly, it is possible to suppress the vehicle M from exceeding the speed limit when traveling on curved roads and to realize safer traveling control.

Here, since the curvature radius for setting the first target speed is recognized by a camera image, etc., for example, the driver's steering operation (e.g., turning the steering wheel further or further back) may change the attitude of the vehicle M relative to the traveling lane, and hence the recognized curvature radius may change significantly (different from the actual curvature radius). Therefore, as shown in FIG. 3, even if the second curvature radius based on the map information is R1, the value of the first curvature radius acquired based on the detection result of the external environment detection device DD such as the camera 10 or the yaw rate (or steering angle) of the vehicle M may change to R2 or R3. For example, when the first curvature radius is determined to be R3 (equal to or larger than R1), a second target speed TSa is set, which is a target speed smaller than the first target speed TSb, whereas when the first curvature radius is smaller than R1 (for example, when the first curvature radius is determined to be R2), a first target speed TSc smaller than the second target speed TSa is selected. Therefore, when the driver steers on a curved road, the first target speed and the second target speed serving as the reference may frequently change, and accordingly, the target speed serving as the reference for the speed control as shown in FIG. 4 may also change, which may result in unstable speed control (the speed VM of the vehicle M may fluctuate).

Therefore, when a curved road is present in the traveling direction of the vehicle M, the target speed setting unit 142 sets a new target speed using information on both the first target speed and the second target speed to thereby enable a target speed with little difference to be set. Accordingly, fluctuation in speed VM when traveling on a curved road can be suppressed.

For example, the target speed setting unit 142 multiplies both the first target speed and the second target speed by a value based on a corresponding predetermined transition ratio α, and adds the multiplication results to adjust the target speed. Specifically, the target speed setting unit 142 calculates the target speed based on the following formula (1).

Target speed=(first target speed) ×α+(second target speed)×(1−α) (1)

In the above formula (1), the transition ratio α is set, for example, according to the traveling conditions of the vehicle M. For example, the transition ratio α is set according to the relative speed ΔV between the target speed for the minimum curvature radius Rmin within the detection range of the curved road and the speed VM of the vehicle M. For example, when the relative speed ΔV changes from 30 [km/h] to 0 [km/h], the transition ratio α is changed from 0 to 1 according to the transition. Therefore, if the relative speed ΔV is large, the value by which the first target speed is multiplied becomes small, and the value by which the second target speed is multiplied becomes relatively large. Furthermore, the numerical values are merely examples and are not limited thereto.

For example, when using the formula (1), immediately after the vehicle M recognizes a curved road (for example, near point X1 shown in FIG. 2), the target speed switches from the target speed TS1 to the target speed TS2 according to the curved road, and the relative speed ΔV at this point becomes large (the transition ratio α approaches 0). Therefore, the ratio of the target speed when traveling in this vicinity to the second target speed (the value related to the ratio to be multiplied in the formula (1)) is larger than the value for the first target speed. As a result, the second target speed is set to a target speed that has a higher priority (has a greater influence) than the first target speed. Accordingly, when the relative speed ΔV is large, the value of the second target speed based on map information in which there is no speed change (small speed change amount) due to steering operation, etc. can be given priority, thereby enabling more stable speed control to be executed.

Further, when the speed control is executed, as shown in FIG. 2, the relative speed ΔV between the speed VM of the vehicle M and the target speed becomes smaller as the vehicle approaches the curved road (the speed VM of the vehicle M approaches the target speed, or the transition ratio α approaches 1). Therefore, the target speed is set that has a large ratio to the first target speed (large influence) and a small ratio to the second target speed (small influence). Therefore, in the example of FIG. 2, when the vehicle is traveling on a curved road (between points X2 and X3), the relative speed ΔV is small, so that the target speed is set such that the influence of the first target speed is large (the first target speed is prioritized). Accordingly, when the relative speed ΔV is small, speed control is executed according to the first target speed set based on the detection result of the external environment detection device DD.

Thus, in the embodiment, when traveling near a curved road, the target speed is set by combining the first target speed and the second target speed in a predetermined ratio depending on the traveling conditions of the vehicle M, thereby suppressing changes in the target speed caused by switching between the first target speed and the second target speed in relation to the curvature radius of the curved road. Furthermore, since fluctuation in the target speed can be suppressed, it is possible to suppress speed control that is not appropriate to the surrounding conditions from being performed by setting an arbitrarily small target speed using only the target speed based on map information.

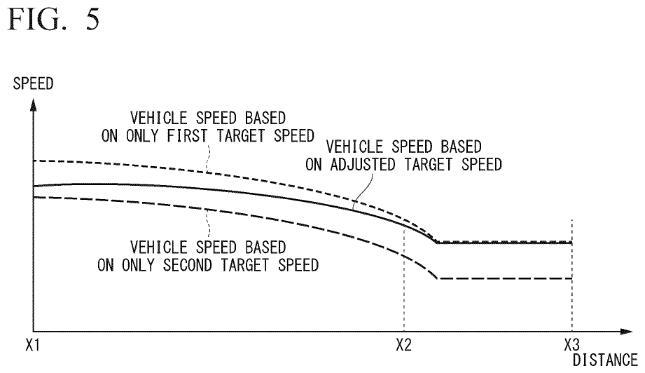

FIG. 5 is a diagram illustrating a speed change of the vehicle M based on the adjusted target speed. The target speed setting unit 142 executes speed control prioritizing the second target speed before the curved road based on the first target speed, the second target speed, and the transition ratio α, and executes speed control prioritizing the first target speed on the curved road, so that the speed is changed smoothly. Therefore, the fluctuation of the speed change can be suppressed by the adjusted target speed, and more appropriate speed control can be realized.

### Process Flow

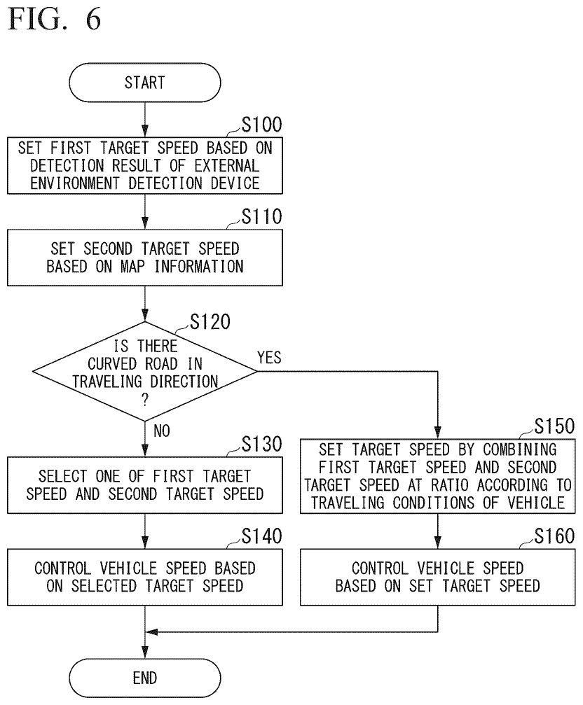

FIG. 6 is a flowchart showing an example of a process executed by the driving assistance device 100 in the embodiment. In the example of FIG. 6, the speed control process related to cruise control will be mainly described among the processes executed by the driving assistance device 100. The process of FIG. 6 may be repeatedly executed at a predetermined timing or at a predetermined cycle while cruise control is being executed, for example.

In the example of FIG. 6, the target speed setting unit 142 sets a first target speed based on the detection result of the external environment detection device DD (step S100). In the process of step S100, the target speed setting unit 142 acquires the curvature radius of the traveling lane of the vehicle M based on the detection result of the external environment detection device DD, and sets a first target speed according to the acquired curvature radius. Next, the target speed setting unit 142 refers to map information based on the position information of the vehicle M, and sets a second target speed based on the map information (step S110). In the process of step S110, the target speed setting unit 142, for example, acquires the curvature radius of the traveling lane of the vehicle M from map information, and sets a second target speed according to the acquired curvature radius.

Next, the speed control unit 144 determines whether or not a curved road (a road with a curvature radius smaller than a threshold) is present in the traveling direction of the vehicle M (step S120). When it is determined that no curved road is present, the speed control unit 144 selects one of the first target speed and the second target speed (step S130), and controls the speed VM of the vehicle M based on the selected target speed (step S140). Further, when it is determined in the process of step S120 that a curved road is present in the traveling direction of the vehicle M, the target speed setting unit 142 sets a target speed that combines the first target speed and the second target speed at a ratio according to the traveling conditions of the vehicle M (step S150). In the process of step S150, the target speed setting unit 142 calculates the target speed using, for example, the above-described formula (1). Next, the speed control unit 144 controls the speed of the vehicle M based on the set target speed (step S160). Accordingly, the process of this flowchart ends.

### MODIFIED EXAMPLES

In the embodiment, instead of (or in addition to) a case where a curved road is present in the traveling direction of the vehicle M, when the occupant selects to execute control to set a target speed that combines the first target speed and the second target speed via the HMI 30, the above-described setting of the target speed may be performed regardless of whether or not the curved road is present. In this case, when executing predetermined driving control such as cruise control, the HMI control unit 160 may output inquiry information to the HMI 30 to inquire of the occupant about the control content, and execute switching control based on the result of the inquiry.

Further, the target speed setting unit 142 does not need to execute a process of setting the target speed by combining the first target speed and the second target speed even when a curved road is present in the traveling direction of the vehicle M when the traveling lane (curvature radius) cannot be recognized from the detection result of the external environment detection device DD based on the surrounding conditions of the vehicle M such as weather and the presence of surrounding vehicles (or when it is determined that the recognition accuracy of the road dividing line has decreased). In this case, the target speed setting unit 142 controls the speed VM of the vehicle M based on the second target speed based on the map information, or ends the cruise control. Accordingly, appropriate control according to vehicle conditions can be realized. The above-described curvature radius may be replaced with curvature, in which case the magnitude relationship (determination condition, etc.) in the control may be reversed or otherwise modified as appropriate.

As described above, according to the embodiment, a non-transient storage medium stores computer-readable instructions for execution by a computer, and the instructions include: recognizing surrounding conditions of the vehicle M based on a detection result of the external environment detection device DD; setting a first target speed of the vehicle M based on the surrounding conditions; setting a second target speed of the vehicle based on map information; and selecting one of the first target speed and the second target speed and controlling the speed of the vehicle M based on the selected target speed. The instructions further include: setting a target speed by combining the first target speed and the second target speed at a ratio according to the traveling conditions of the vehicle when a curved road is present in the traveling direction of the vehicle M; and controlling the speed of the vehicle based on the set target speed. Accordingly, a more appropriate target speed can be set even on curved roads. Therefore, for example, when driving control such as cruise control is executed, more appropriate speed control can be realized.

Specifically, according to the embodiment, the curvature radius (or curvature) of the curved road is acquired from the recognition result by the external environment detection device DD and the map information, the target speed for each acquired curvature radius is set, and in a control in which one of the target speeds is selected and the vehicle speed is adjusted when there is a difference between the target speeds, the target speed is adjusted so that the influence of the target speed using map information is larger (priority is given) when the relative speed between the target speed and the vehicle speed is large. Accordingly, for example, in speed control before entering a curve or while traveling in the curve, a target speed with little fluctuation is set based on map information, so that fluctuation in speed can be suppressed. Further, according to the embodiment, since the lower vehicle speed is selected when there is a difference between the target speeds, it is possible to suppress the vehicle from speeding excessively on curved roads.

Further, according to the embodiment, it is possible to realize more appropriate traveling control based on the actual surrounding conditions using the recognition results by the external environment detection device DD in a situation close to the target speed by adjusting the target speed so that the influence of the target speed set by the recognition results of the external environment detection device DD is large and the influence of the target speed due to the map information is small when the relative speed is small. Further, according to the embodiment, since speed control is executed based on highly accurate map information before entering a curve and is executed so that the difference with the target speed due to the surrounding recognition decreases after entering the curve, fluctuation in the speed VM of the vehicle M can be suppressed, and more stable speed control can be realized.

The above-described embodiment can be expressed as follows.

A vehicle control device includes:
a storage medium storing computer-readable instructions; and
a processor connected to the storage medium,
wherein the processor executes the computer-readable instructions for:
recognizing surrounding conditions of a vehicle based on detection result of an external environment detection device;
setting a first target speed of the vehicle based on the surrounding conditions;
setting a second target speed of the vehicle based on map information;
selecting one of the first target speed and the second target speed and controlling a speed of the vehicle based on the selected target speed;
setting a target speed by combining the first target speed and the second target speed at a ratio according to traveling conditions of the vehicle when a curved road is present in a traveling direction of the vehicle; and
controlling the speed of the vehicle based on the set target speed.

Although the embodiment of the present invention has been described above, the present invention is not limited to these embodiments, and various modifications and substitutions can be made without departing from the spirit and scope of the present invention.

What is claimed is:

1. A non-transient storage medium storing computer-readable instructions to be executed by a computer,
wherein the instructions include recognizing a surrounding conditions of a vehicle based on detection result of an external environment detection device, setting a first target speed of the vehicle based on the surrounding conditions, setting a second target speed of the vehicle based on map information, selecting one of the first target speed and the second target speed and controlling a speed of the vehicle based on the selected target speed, setting a target speed by combining the first target speed and the second target speed at a ratio according to traveling conditions of the vehicle when a curved road is present in a traveling direction of the vehicle, and controlling the speed of the vehicle based on the set target speed.

2. The storage medium according to claim 1,
wherein the instructions include increasing a ratio of the second target speed when a relative speed between the target speed and the speed of the vehicle is large.

3. The storage medium according to claim 1,
wherein the instructions include increasing a ratio of the smaller target speed between the first target speed and the second target speed when a relative speed between the target speed and the speed of the vehicle is large.

4. The storage medium according to claim 1,
wherein the instructions include setting the first target speed and the second target speed according to a curvature radius or curvature of the curved road.

5. The storage medium according to claim 4,
wherein the instructions include adjusting the first target speed based on a yaw rate or steering angle of the vehicle.

6. A vehicle control device comprising:
a recognition unit which recognizes a surrounding conditions of a vehicle based on detection result of an external environment detection device;
a target speed setting unit which sets a first target speed of the vehicle based on the surrounding conditions recognized by the recognition unit and sets a second target speed of the vehicle based on map information; and
a speed control unit which selects one of the first target speed and the second target speed and controls the speed of the vehicle based on the selected target speed,
wherein the target speed setting unit sets a target speed by combining the first target speed and the second target speed at a ratio according to traveling conditions of the vehicle when a curved road is present in a traveling direction of the vehicle, and
wherein the speed control unit controls the speed of the vehicle based on the set target speed.

7. A vehicle control method for causing a computer to execute:
recognizing surrounding conditions of a vehicle based on detection result of an external environment detection device;
setting a first target speed of the vehicle based on the surrounding conditions;
setting a second target speed of the vehicle based on map information;
selecting one of the first target speed and the second target speed and controlling a speed of the vehicle based on the selected target speed;
setting a target speed by combining the first target speed and the second target speed at a ratio according to traveling conditions of the vehicle when a curved road is present in a traveling direction of the vehicle; and
controlling the speed of the vehicle based on the set target speed.
